(19) United States
(12) Patent Application Publication
(10) Pub. No.: US 2004/0219497 A1
(43) Pub. Date: Nov. 4, 2004

(54) Typewriting sentence learning system and method with hint profolio

(76) Inventors: Say-Ling Wen, Taipei (TW); Zechary Chang, Taipei (TW); Yeats Gu, Beijing (CN)

Correspondence Address: BIRCH STEWART KOLASCH & BIRCH, PO BOX 747, FALLS CHURCH, VA, 22040-0747, US

(21) Appl. No.: 10/424,786

(22) Filed: Apr. 29, 2003

(51) Int. Cl. G09B 19/00

(52) U.S. Cl. 434/167

(57) ABSTRACT

The specification discloses a typewriting sentence learning system and the corresponding method with hint profolio. A hint module output a combination of hints in a sentence database. A result comparison module compares the sentence entered by the learner with the correct answer and sends the comparison result to a level tuning module. The level tuning module then adjusts the difficulty of the problems. Since the invention increases the learning difficulty because of the learner has to type in his or her answer, the learner does not only improve in the sentence organization ability but also the typewriting ability.

### BACKGROUND OF THE INVENTION

1. Field of Invention

The invention relates to a computer-aided foreign sentence learning system and the corresponding method. In particular, it relates to a typewriting sentence learning system and method with tunable difficulty in problems.

2. Related Art

The foreign language learning can be divided into four major topics: listening, speaking, reading, and writing. Speaking is the oral expression, which concerns how to speak a sentence. Writing deals with the sentence making in writing. Therefore, making a sentence is the most basic skill in a language. It is thus an important subject in the foreign language learning. One has to learn to organize vocabulary and phrases according to the syntax. Through the sentence making practice, the learner does not only learn how to use single words in different environments, but also remember the spelling of the words at the same time. It is therefore a better learning method for a learner to master a language by enhancing the syntax structures.

There are many ways to learn how to make sentences. Generally speaking, the conventional sentence learning methods include: shuffle words and ask the learner to recombine them into a meaningful sentence; provide varied forms of words for the learner to select correct forms according to the tense of the current sentence; add interfering words, such as synonyms and words with similar meanings, and ask the learner to select a most appropriate word. A typical model is to provide words in a random order for the learner to organize into a meaningful sentence. For example:

The computer shows in a random order: dog, the, caught, the, in, the, mouth, hold, of, ball.

The learner makes the following sentence: The dog caught hold of the ball in its mouth.

All these methods involve simple and basic practices because the correct answer is always contained in the selection items. The learner only needs to make selections within the provided words and phrases. There is not much room for the learner to think. Consequently, the learner cannot learn how to make up a sentence by himself or herself. The learner only places the attention on the words or phrases, not the full sentence. Moreover, the cost and work involved in making the software are tremendously increased because of the interfering selections.

As advanced practices, it is preferable for the learner to make sentences according to a real situation. However, sentence learning often departs from the actual language application. In reality, only picture scenes and concepts are provided for the learner to make sentences. As there are many ways to express the ideas and there are problems of checking the syntax structure and identifying the sentence meaning, the software design thus faces great difficulties. Many systems cannot overcome the above problems and simply avoid doing so. Therefore, there has not been such an ideal learning system for learner to practice sentences.

### SUMMARY OF THE INVENTION

To solve the above-mentioned problems in the prior art, the invention provides a typewriting sentence learning system and method with hint profolio. Through hints with varying difficulties, the system enables the learner to type in a full sentence.

The invention provides a typewriting sentence learning system with hint profolio, which includes a sentence database, a hint module, an input receiving module, a result comparison module, and a level tuning module. The sentence database stores more than one sentence data and several hint data corresponding to the sentence. The hint module confirms and outputs a combination of the hint data according to the current difficult level. The input receiving module receives a sentence content entered by the learner. The result comparison module performs real-time comparisons between the entered sentence with the original sentence in the sentence database and outputs the comparison result. The level tuning module determines a difficulty level according to the comparison result. The difficulty level is then sent to the hint module for further processing.

The invention also provides a typewriting sentence learning method with hint profolio. According to the method, the system first extracts an original sentence and its associated hint data. Afterwards, the system outputs a combination of the hint data according to the current difficulty level. After receiving a sentence content entered by the learner, the system compares it with the original sentence and outputs the comparison result. Finally, the system adjusts the difficulty level according to the comparison result.

The system and method provided by the invention performs real-time judgment on the sentence entered by the learner. The comparison result is used to automatically adjust the difficulty level. Therefore, the invention enhances the interactions between the learner and the computer, thereby increasing the learner's interest. The keyboard input replaces the handwritten input of the current technology. This does not train the learner's typewriting ability, but also make it easy for the computer to compare results. The bilingual display enhances the learner's association memory, sentence organization ability, spelling, and typewriting.

### BRIEF DESCRIPTION OF THE DRAWINGS

The invention will become more fully understood from the detailed description given hereinbelow illustration only, and thus are not limitative of the present invention, and wherein:

FIG. 1 shows the modules of the disclosed typewriting sentence learning system and method with hint profolio;

FIG. 2 is a flowchart of the disclosed method;

FIG. 3 is a flowchart of making a problem and the associated hint according to the invention; and

FIGS. 4A through 4G are schematic views of decreasing the difficulty level in an embodiment of the invention.

### DETAILED DESCRIPTION OF THE INVENTION

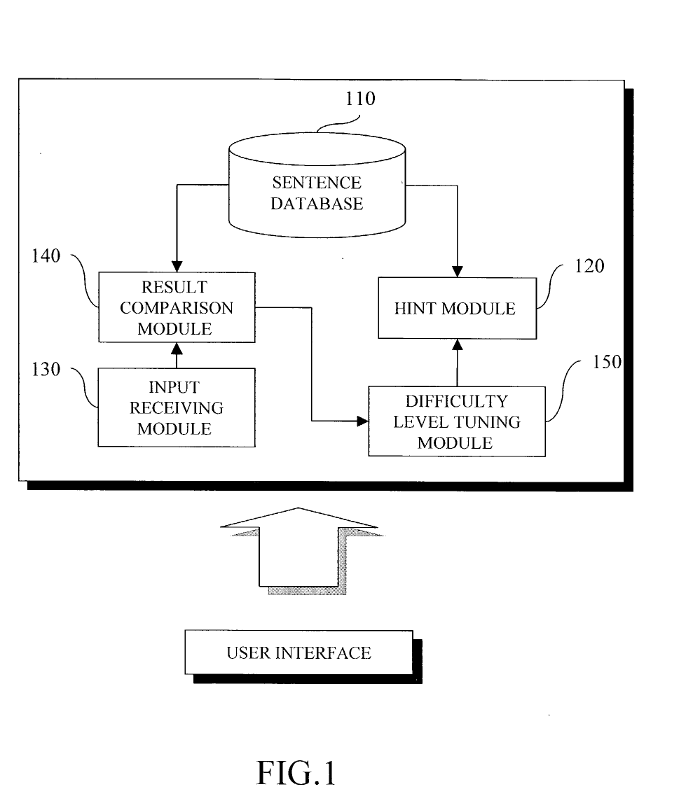

With reference to FIG. 1, the structure of the invention includes: a sentence database 110, a hint module 120, an input receiving module 130, a result comparison module 140, and a level tuning module 150.

The sentence database 110 stores at least one original sentence data and several associated hint data. The hint data include: voice contents of sentences, pictures, mother language translation, first letters of words, number of letters in a word, key words, and random word orders (the word may include interfering ones).

The hint module 120 forms and outputs hint information according to the current difficulty level. Different hint data combinations correspond to different difficulty levels. The more concrete the hint information is, the lower the difficulty level is. The most difficult level only provides a single hint datum.

The input receiving module 130 receives a sentence entered by the learner. The learner enters the sentence through a keyboard according to the provided hint data.

The result comparison module 140 performs a real-time comparison between the received sentence and the original sentence in the sentence database 110. If the entered sentence is compatible with the original sentence, then the module displays OK and the original sentence for the learner's reference. Afterwards, the system goes on to the next sentence practice. If the entered sentence is incompatible with the original sentence, then the module provides the comparison result to the level tuning module.

The level tuning module 150 adjusts the difficulty level according to the comparison result. The difficulty level is given to the hint module 120 at the same time.

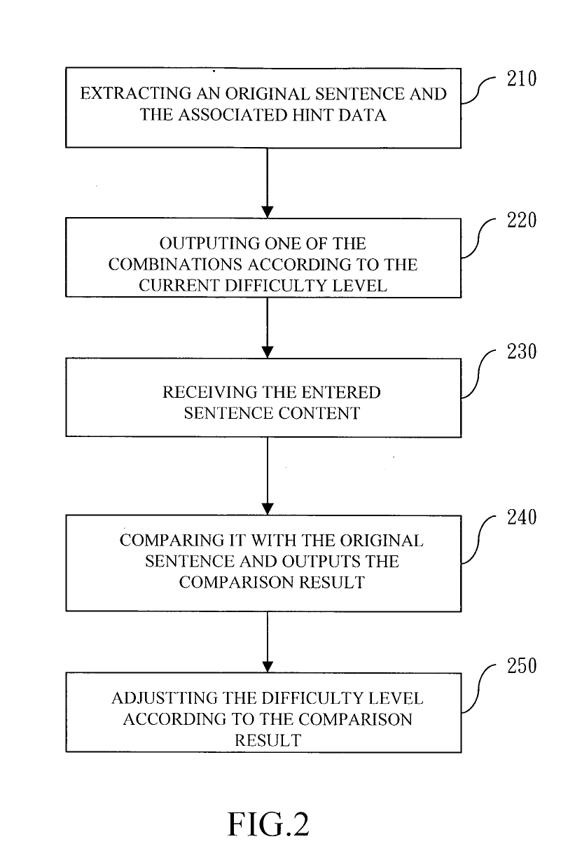

With reference to FIG. 2, as the typewriting sentence learning begins, the system extracts an original sentence and the associated hint data from the sentence database 110 (step 210). The purpose is to provide a concrete sentence for making a problem. The hint data have different combinations for different difficulty levels. The hint module 120 outputs one of the combinations according to the current difficulty level (step 220). The learner practices making a sentence according to the provided hint data and enters the sentence using a keyboard. After receiving the entered sentence content (step 230), the result comparison module 140 compares it with the original sentence and outputs the comparison result (step 240). The level tuning module then adjusts the difficulty level according to the comparison result (step 250). The adjusted difficulty level is sent to the hint module 120.

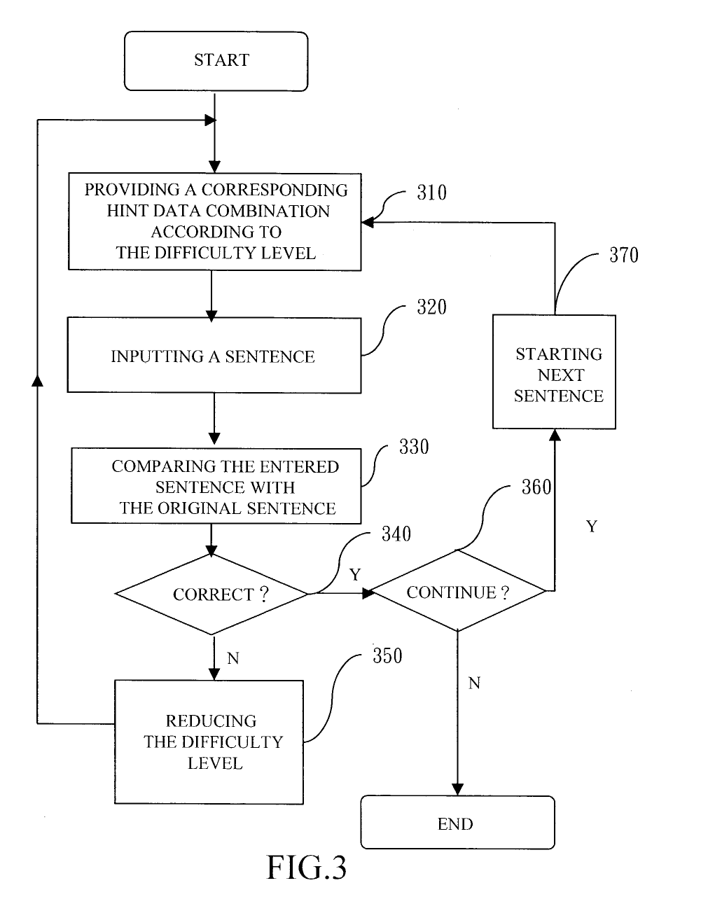

In fact, the essence of the invention is to determine the difficulty level according to the input content by the user and to provide a hint combination according to the difficulty level. In the following text, we use FIG. 3 to explain in detail how a problem and the associated hint are formed in the disclosed system and method.

In the beginning of the typewriting sentence practice, the user specifies a difficulty level. According to the user entered difficulty level, the system provides a corresponding hint data combination (step 310). If the user does not specify a difficulty level, the system takes the hardest level as the default. The learner then input a sentence (step 320). The system compares the entered sentence with the original sentence (step 330), determines whether the entered sentence is correct and outputs a comparison result (step 340). If the entered sentence is not correct, then difficulty level is lowered (step 350). By lowering the difficulty level, the learner is provided with more concrete hint data until the learner can provide the correct sentence. At this point, the system simultaneously shows the original sentence for the learner's reference. Afterwards, the system asks the learner whether to continue practicing (step 360). If the learner wants to continue, the next sentence starts (step 370); otherwise, the procedure finishes.

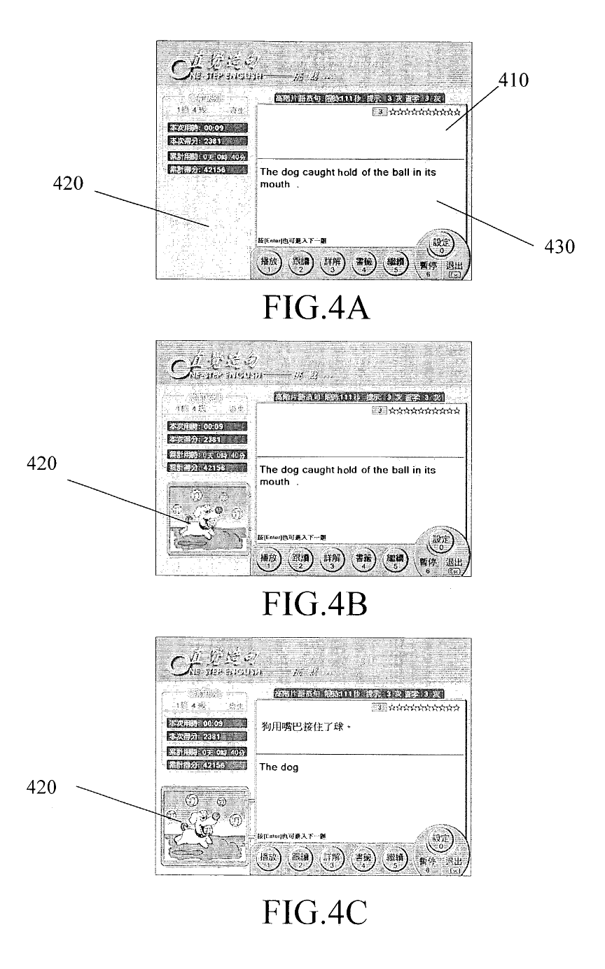

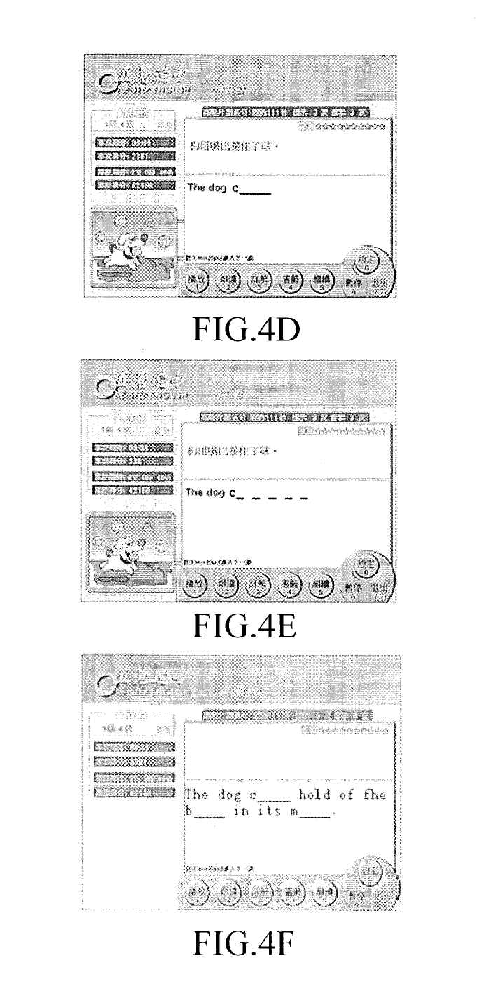

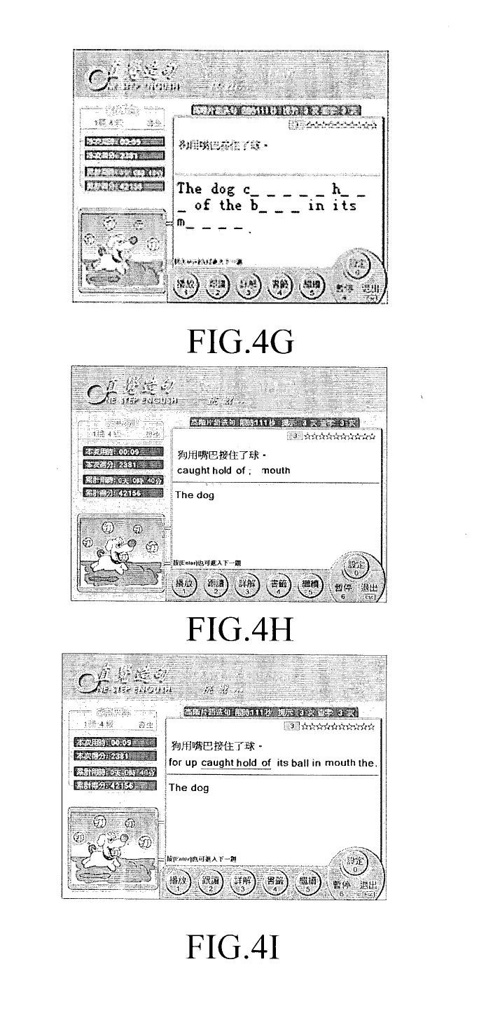

In the following, we use an English typewriting sentence practice as an example to explicitly illustrate the cases with decreasing difficulty levels, with reference to FIGS. 4A to 4G. For decreasing difficulty levels, the hint data become more and more concrete so that the learner have less difficulty in completing the sentence. Suppose the original sentence is “The dog caught hold of the ball in its mouth.” The hint data are voices, pictures, mother language translation, first letters of words, number of letters in a word, key words (caught hold of, mouth), words arranged in a random order (for up caught hold of its ball in mouth the dog).

We define the hint data with decreasing difficulty levels as follows:

First level: simply listen voices and type in the sentence;

Second level: provide voices+pictures;

Third level: provide voices+pictures+mother language translation;

Fourth level: provide voices+pictures+mother language translation+first letters of words to be entered;

Fifth level: provide voices+pictures+mother language translation+first letters of words to be entered+number of letters of words to be entered;

Sixth level: provide voices+pictures+mother language translation+first letters of all key words;

Seventh level: provide voices+pictures+mother language translation+first letters of all key words+numbers of letters of all key words;

Eighth level: provide voices+pictures+mother language translation+key words;

Ninth level: provide voices+pictures+mother language translation+all words arranged in a random order.

FIG. 4A shows the display interface of providing only the voice hint data. The corresponding difficulty is the first level. There is only one hint combination, which is the voice of the sentence. The bilingual comparison area 410 and the picture hint area 420 are both empty. The learner only hears the voice of the sentence “The dog caught hold of the ball in its mouth,” and then types in the sentence. The entered sentence is shown in the typewriting sentence display area 430. FIG. 4B has a lower difficulty than FIG. 4A. It provides the voice and picture hints. The learner can obtain more information from the pictures shown in the picture hint area 420. FIG. 4C corresponds to the third difficulty level. In addition to the above-mentioned hint data, it also shows the mother language translation. Therefore, the learner can combine the hints of voices, pictures, and mother language translation to make the sentence. FIG. 4D shows the fourth difficulty level. In the hint data, the first letter of the next word to be entered is given. The learner then finds the word starting with the letter. In FIG. 4E, not only is the first letter of the next word to be entered is given, the spaces for letters are also shown so that the learner knows how many letters there are in the word. FIG. 4F further provides the first letters of all key words. FIG. 4G provides the spaces for all key words for the learner to fill in. FIGS. 4H and 4I correspond to the eighth and ninth levels, where all key words and all words arranged in a random order are provided. With both the mother language translation and the words in the foreign language, the learner can enter the sentence with more ease.

The above-mentioned hint data are provided for the learner to compose the sentence. Of course, there are infinite possibilities of hint data that can achieve equivalent effects. The only purpose is to guide the learner to enter the correct sentence. All these should be construed to be within the scope of the invention.

Certain variations would be apparent to those skilled in the art, which variations are considered within the spirit and scope of the claimed invention.

What is claimed is:

1. A typewriting sentence learning system with hint profolio, which comprising:
a sentence database, which stores more than one original sentence datum and a plurality of associated hint data for each of the original sentence;
a hint module, which determines and outputs a combination of hint data according to the current difficulty level;
an input receiving module, which receives a sentence entered by a learner by typewriting;
a result comparison module, which compares the entered sentence with the original sentence in the sentence database in real time and outputs the comparison result; and
a difficulty level tuning module, which determines a difficulty level according to the comparison result and passes the difficulty level to the hint module.

2. The system of claim 1, wherein the hint data include for the sentence a voice content, pictures, first letters of words, number of letters in a word, key words, all words in a random order, and translated text in the learner's mother language.

3. The system of claim 1, wherein the difficulty level determines the combination of the hint data, the less hint data corresponding to a higher difficulty level and the number of hint data provided in the hardest difficulty level is one.

4. The system of claim 1, wherein the system ends the practice of the current sentence and displays the original sentence for the learner's reference once the result comparison module determines that the entered sentence is correct.

5. The system of claim 1, wherein the difficulty level tuning module lowers the difficulty level if the result comparison module determines that the entered sentence is incorrect.

6. The system of claim 5, wherein by lowering the difficulty level the system further provides the learner with more concrete hint data.

7. A typewriting sentence learning method with hint profolio, which comprising the following steps:
extracting an original sentence and all of the associated hint data;
outputting a combination of the hint data according to the current difficulty level;
receiving a sentence entered by a learner by typewriting;
comparing the entered sentence with the original sentence and outputting a comparison result; and
adjusting the difficulty level according to the comparison result.

8. The method of claim 7, wherein the hint data include for the sentence a voice content, pictures, first letters of words, number of letters in a word, key words, all words in a random order, and translated text in the learner's mother language.

9. The method of claim 7, wherein the difficulty level determines the combination of the hint data, the less hint data corresponding to a higher difficulty level and the number of hint data provided in the hardest difficulty level is one.

10. The method of claim 7, wherein the current difficulty level is assigned by the learner at the beginning of the program.

11. The method of claim 7, wherein the system takes the hardest difficulty level as the current difficulty level by default.

12. The method of claim 7, wherein the step of adjusting the difficulty level according to the comparison result ends the practice of the current sentence and displays the original sentence for the learner's reference if the comparison result is completely correct.

13. The method of claim 7, wherein the step of adjusting the difficulty level according to the comparison result reduces one difficulty level if the comparison result is incorrect.

14. The method of claim 13, wherein by lowering the difficulty level more concrete hint data are provided to the learner.
